(19) United States
(12) Patent Application Publication
(10) Pub. No.: US 2023/0162017 A1
(43) Pub. Date: May 25, 2023

(54) Mobile Terminal and Distributed Deep Learning System

(71) Applicant: Nippon Telegraph and Telephone Corporation, Tokyo (JP)

(72) Inventors: Kenji Tanaka, Tokyo (JP); Mitsumasa Nakajima, Tokyo (JP); Toshikazu Hashimoto, Tokyo (JP); Takeshi Sakamoto, Tokyo (JP)

(21) Appl. No.: 17/916,770

(22) PCT Filed: Apr. 23, 2020
(86) PCT No.: PCT/JP2020/017485

§ 371 Date: Oct. 3, 2022

(51) Int. Cl. G06N 3/067; G06N 3/0455

(52) U.S. Cl. CPC G06N 3/0675; G06N 3/0455

(57) ABSTRACT

A mobile terminal includes a sensor that acquires information from a surrounding environment, an LD that converts an electrical signal output from the sensor into an optical signal, an optical processor that extracts a feature quantity of the information transmitted by the optical signal and outputs an optical signal including an extraction result, a PD that converts an optical signal output from the optical processor into an electrical signal, and a communication circuit that transmits a signal output from the PD to a cloud server that performs processing of the FC layer of the DNN inference.

### CROSS-REFERENCE TO RELATED APPLICATIONS

This application is a national phase entry of PCT Application No. PCT/JP2020/017485, filed on Apr. 23, 2020, which application is hereby incorporated herein by reference.

### TECHNICAL FIELD

The present disclosure relates to distributed deep learning by using a mobile terminal.

### BACKGROUND

For deep learning, various applications have been proposed due to high performance and wide application range thereof and have exhibited performance exceeding that of the related art. On the other hand, when achieving high performance in inference of deep learning is attempted, a neural network model of deep learning becomes large, and the computational complexity required from data input to output will increase. Computational operations in an electronic circuit are performed by transistors, and thus when the computational complexity increases, power consumption increases by the increase in the computational complexity. As a method of suppressing the power consumption, there is a method of suppressing voltage and current to be supplied to transistors, intentionally reducing a clock frequency, and the like. However, with such a method, there is a problem that the processing time of computational operation increases, and it is not suitable for an application area in which a low delay response is desired.

The problem of power consumption and response time required for deep learning is significant when a deep neural network (DNN) inference is performed by a mobile terminal. The reason for performing the DNN inference on the mobile device is that the response time can be shortened compared to a case where data is transmitted to and processed by a cloud server. The reason that the response time can be shortened is that if the size of data obtained from a sensor is large, a delay in communication occurs when this data is sent to the cloud server to perform the DNN inference at the server.

Demand for low delay DNN inferences is high, and the low delay DNN inferences has attracted attention in fields such as autonomous driving and natural language translation, for example. On the other hand, all the power supply to the mobile terminal is performed from the battery, and because the technical progress of increasing the capacity of the battery is slow, it has been difficult to provide for all the power consumption required for deep learning by the battery.

An overview of DNN processing of the related art by using a mobile terminal is illustrated in FIG. 8. In the related art, focusing on the data size during the processing of DNN and the processing delay of each layer, a method has been proposed in which a computational operation of a layer 201 near an input layer of a neural network model 200 is performed by a mobile terminal wo, results of computational operations are transmitted to a cloud server 101 via a network 102, and a computational operation of a layer 202 near an output layer is performed by a cloud server 101 (see NPL 1).

In a common DNN, feature extraction is performed near the input layer, and near the output layer is a full connection layer (FC layer). The feature extraction is processing that extracts features used for inference from large size input data. This feature extraction compresses the data size. When the data size is compressed, the communication time between the mobile terminal and the cloud server is reduced, and a bottleneck in inferring the DNN in the cloud server is eliminated.

Further, the FC layer near the output layer has very high memory access. With a high-performance central processing unit (CPU) of the cloud server, the cost of memory access can be reduced with plenty of cache or by using functions such as prefetch. However, in the CPU of the mobile terminal, the dynamic random access memory (DRAM) needs to be accessed frequently during processing of the FC layer because there is no function such as prefetch. Access to DRAM is known to be costly compared to access to caches, causing significant increase in delay time and causing significant increase in power consumption. Thus, processing the FC layer on the cloud server instead of processing it on the mobile terminal may be efficient in terms of delay time and power consumption. In this manner, by performing feature quantity extraction processing of DNN inference on the mobile terminal, it is efficient in terms of delay time and power consumption, but in the related art, it has not been possible to achieve a reduction in power consumption in the mobile terminal.

### CITATION LIST

### Non Patent Literature

NPL 1: Yiping Kang, Johann Hauswald, Cao Gao, Austin Rovinski, Trevor Mudge, Jason Mars, Lingjia Tang, “Neurosurgeon: Collaborative Intelligence Between the Cloud and Mobile Edge”, ACM SIGARCH Computer Architecture News, pp. 615-629, 2017.

### SUMMARY

### Technical Problem

The present disclosure has been made to solve the above problems, and an object thereof is to provide a mobile terminal and a distributed deep learning system capable of reducing power consumption of a mobile terminal used for feature quantity extraction processing of DNN inference.

### Means for Solving the Problem

A mobile terminal of the present disclosure includes a sensor that acquires information from a surrounding environment and outputs an electrical signal transmitting the information, a first light emitting element that converts the electrical signal output from the sensor into an optical signal, a first optical processor that extracts a feature quantity of the information transmitted by the optical signal and outputs an optical signal including an extraction result, a first light receiving element that converts the optical signal output from the first optical processor into an electrical signal, and a first communication circuit that transmits a signal output from the first light receiving element to an external processing apparatus that performs processing of a full connection (FC) layer of a deep neural network (DNN) inference and that receives a signal transmitted from the external processing apparatus.

Further, a distributed deep learning system of the present disclosure includes the mobile terminal described above, and a processing apparatus that performs processing of a full connection (FC) layer of a deep neural network (DNN) on a signal received from the mobile terminal.

Further, a distributed deep learning system of the present disclosure includes the mobile terminal described above, a first processing apparatus that performs processing of a full connection (FC) layer of a deep neural network (DNN) on a signal received from the mobile terminal and calculates entropy of an inference result obtained by the processing of the FC layer, and a second processing apparatus that terminates a DNN inference when a result of the entropy is larger than a threshold that is predetermined and further performs processing of the FC layer on the inference result transmitted from the first processing apparatus when the result of the entropy is less than or equal to the threshold, in which the first processing apparatus includes a second communication circuit that receives the signal transmitted from the mobile terminal, a second light emitting element that converts an electrical signal received by the second communication circuit into an optical signal, a second optical processor that performs processing of the FC layer of the DNN on a feature quantity transmitted by the optical signal output from the second light emitting element and outputs an optical signal including an inference result obtained by the processing of the FC layer, a second light receiving element that converts the optical signal output from the second optical processor into an electrical signal, and a third communication circuit that transmits a signal output from the second light receiving element to the second processing apparatus and receives a signal transmitted from the second processing apparatus.

### Effects of Embodiments of the Invention

According to the present disclosure, by performing feature quantity extraction processing on a mobile terminal with a high speed and low power consumption optical processor, it is possible to reduce the power consumption of the mobile terminal required for the feature quantity extraction processing.

### BRIEF DESCRIPTION OF THE DRAWINGS

FIG. 1 is a block diagram illustrating a configuration of a distributed deep learning system according to a first example of the present disclosure.

FIG. 2 is a flowchart describing an inference operation of the distributed deep learning system according to the first example of the present disclosure.

FIG. 3 is a block diagram illustrating a configuration of a distributed deep learning system according to a second example of the present disclosure.

FIG. 4 is a block diagram illustrating a configuration of a distributed deep learning system according to a third example of the present disclosure.

FIG. 5 is a block diagram illustrating a configuration of a distributed deep learning system according to a fourth example of the present disclosure.

FIG. 6 is a block diagram illustrating a configuration of a distributed deep learning system according to a fifth example of the present disclosure.

FIG. 7 is a flowchart describing an inference operation of the distributed deep learning system according to the fifth example of the present disclosure.

FIG. 8 is a diagram schematically illustrating processing of a related art DNN by using a mobile terminal.

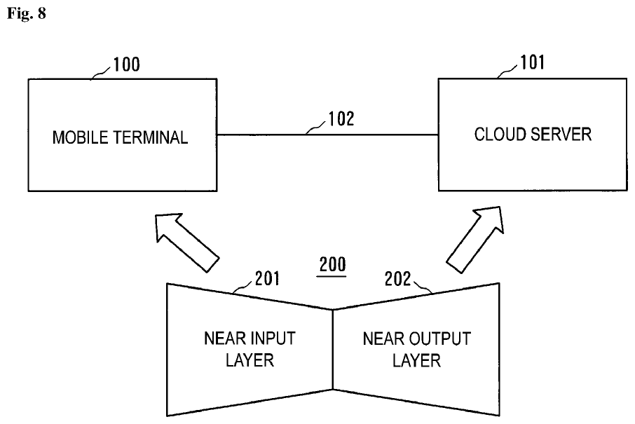

### DETAILED DESCRIPTION OF ILLUSTRATIVE EMBODIMENTS

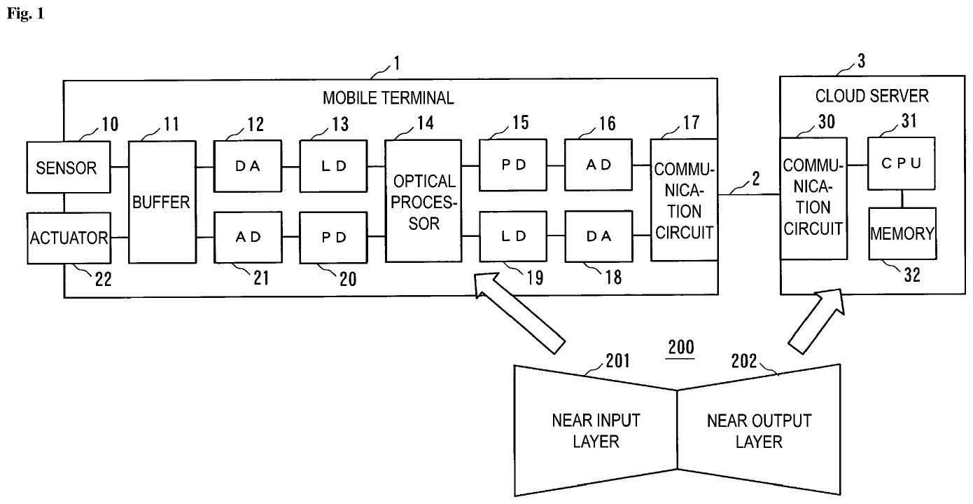

Hereinafter, examples of the present disclosure will be described with reference to the drawings. FIG. 1 is a block diagram illustrating a configuration of a distributed deep learning system according to a first example of the present disclosure. The distributed deep learning system is constituted of a mobile terminal 1 and a cloud server 3 (processing apparatus) connected to the mobile terminal 1 via a network 2.

The mobile terminal 1 includes a sensor 10, a buffer 11, a digital-to-analog converter (DA) 12, a laser diode (LD) 13, an optical processor 14, a photodiode (PD) 15, an analog-to-digital converter (AD) 16, a communication circuit 17, a DA 18, an LD 19, a PD 20, an AD 21, and an actuator 22.

The sensor 10 acquires information from a surrounding environment and outputs digital data. An example of a sensor 10 is an image sensor, for example. However, it goes without saying that the present disclosure is not limited to the image sensor. The DA 12 converts the digital data output from the sensor 10 into an analog electrical signal. The LD 13 (first light emitting element) converts an analog electrical signal output from the DA 12 into an optical signal.

The optical processor 14 captures an optical signal emitted from the LD 13, performs four arithmetic operations by using interference on an internal optical waveguide with respect to the optical signal, and outputs an optical signal including an arithmetic operation result. The optical processor 14 may only use passive optical elements or may include active optical elements such as liquid crystal on silicon (LCOS) elements or Mach-Zehnder waveguides.

The PD 15 (first light receiving element) converts the optical signal output from the optical processor 14 into an analog electrical signal. The AD 16 converts an analog electrical signal output from the PD 15 into digital data.

The communication circuit 17 packetizes digital data output from the AD 16 and transmits the generated packet to the cloud server 3 via the network 2. As is known, the packet includes a header and a payload. The digital data output from the AD 16 is stored in the payload. The network 2 may be either a wired network or a wireless network. Further, the communication circuit 17 extracts payload data from a packet received from the cloud server 3 via the network 2 and outputs the data to the DA 18.

The DA 18 converts digital data output from the communication circuit 17 into an analog electrical signal. The LD 19 converts an analog electrical signal output from the DA 18 into an optical signal. The PD 20 converts the optical signal output from the optical processor 14 into an analog electrical signal. The AD 21 converts an analog electrical signal output from the PD 20 into digital data.

The actuator 22 operates according to digital data output from the AD 21 and stored temporarily in the buffer 11.

The cloud server 3 is installed in a data center. The cloud server 3 has a feature in having abundant computational resources compared to the mobile terminal 1. The cloud server 3 includes a communication circuit 30, a CPU 31, and a memory 32.

The communication circuit 30 extracts payload data from a packet received from the network 2 and outputs the data to the CPU 31. Further, the communication circuit 30 packetizes digital data output from the CPU 31 and transmits the generated packet to the mobile terminal 1 via the network 2.

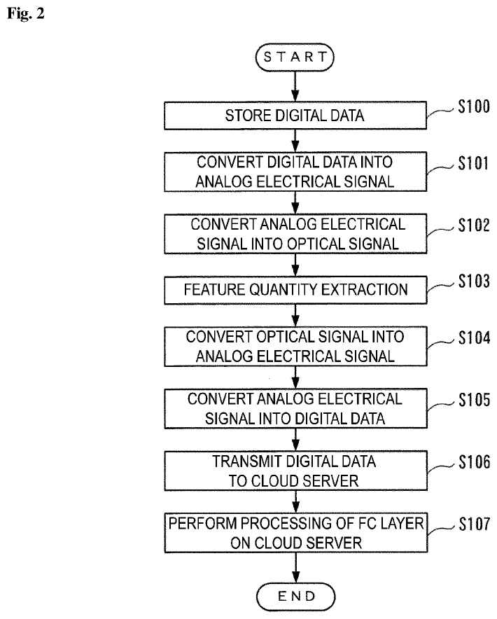

FIG. 2 is a flowchart describing an inference operation of the distributed deep learning system of the present example. The sensor 10 of the mobile terminal 1 acquires information and outputs digital data. This digital data is stored once in the buffer 11 (step S100 in FIG. 2).

The DA 12 of the mobile terminal 1 converts the digital data output from the sensor 10 and accumulated in the buffer 11 into an analog electrical signal (step S101 in FIG. 2).

The LD 13 of the mobile terminal 1 converts an analog electrical signal output from the DA 12 into an optical signal (step S102 in FIG. 2).

The optical processor 14 of the mobile terminal 1 performs four arithmetic operations on an optical signal input from the LD 13. In this manner, the optical processor 14 extracts a feature quantity of information transmitted by the optical signal and outputs an optical signal including an extraction result of the feature quantity (step S103 in FIG. 2).

The PD 15 of the mobile terminal 1 converts the optical signal output from the optical processor 14 into an analog electrical signal (step S104 in FIG. 2). The AD 16 of the mobile terminal 1 converts an analog electrical signal output from the PD 15 into digital data (step S105 in FIG. 2).

The communication circuit 17 of the mobile terminal 1 packetizes digital data output from the AD 16 and transmits the generated packet to the cloud server 3 (step S106 in FIG. 2).

The communication circuit 30 of the cloud server 3 extracts payload data from a packet received from the network 2. The CPU 31 of the cloud server 3 performs processing of the FC layer of the DNN on the data received by the communication circuit 30 from the mobile terminal 1 (step S107 in FIG. 2). Thus, a result of the DNN inference can be obtained. This inference result is used in the next processing at the cloud server 3. The processing that uses the inference result is image recognition or the like, for example, but it goes without saying that the present disclosure is not limited to image recognition.

Further, as a result of processing using the inference result, the CPU 31 generates control data, which is digital data for moving the actuator 22 of the mobile terminal 1.

The communication circuit 30 of the cloud server 3 packetizes control data output from the CPU 31 and transmits the generated packet to the mobile terminal 1 via the network 2. In this manner, the actuator 22 of the mobile terminal 1 can be controlled by transmitting the control data to the mobile terminal 1. Specifically, for example, an example of moving an actuator of a robot, or the like is conceivable, but it goes without saying that the present disclosure is not limited to such an example.

Basically, the optical processor 14 of the present example performs processing corresponding to processing of a related art mobile terminal 100. However, the optical processor 14 performs analog computational operations, whereas the processor of the mobile terminal 100 performs digital computational operations. Thus, the optical processor 14 does not always give exactly the same result as the computational operation performed by the processor of the mobile terminal 100. Further, the relationship between data and a label may change due to a change in the environmental situation. Thus, learning of a neural network may be performed again.

In this case, learning data is acquired by the sensor 10 of the mobile terminal 1, and a DNN inference described in FIG. 2 is executed. The CPU 31 of the cloud server 3 performs relearning of the FC layer of the cloud server 3 by back propagation method so that the inference result approaches a correct answer (teaching data).

One example of the feature extraction processing in the related art mobile terminal is a convolutional calculation or the like. The convolutional calculation does not involve memory access, but it is necessary to drive a large number of transistors to obtain a computational operation result. Further, the digital circuit, which is the platform of the convolutional calculation, operates in synchronization with a clock signal. However, in the mobile terminals, because it is desirable to reduce battery consumption, a high-speed clock signal cannot be used in the mobile terminals.

On the other hand, the optical processor 14 of the present example has a low power consumption because no transistor or the like is used. Further, because the optical signal handled by the optical processor 14 is an analog signal, the operating speed of the optical processor 14 does not depend on the clock signal. Further, the analog signal band of an existing complementary metal oxide semiconductor (CMOS) circuit is approximately 30 GHz. In contrast, compared to the existing CMOS circuit, the optical signal has a signal band of approximately ten times wider. Therefore, in the present example, multiplexing of information that is not possible in the electrical circuit can be applied, and the amount of information per channel can be increased.

Note that the trained optical processor 14 acts as a feature extractor as described above. Feature extraction is to convert a high dimensional signal into a low dimension and to allow for linear separation. If an optical signal is input from the LD 19, the optical processor 14 converts a linearly separable signal into a high dimensional signal and outputs the converted signal to the PD 20. At this time, if learning has been already performed, the conversion works properly, and the high dimensional signal is converted into a most likely signal rather than a disordered signal. This action of the neural network is referred to as a generative network. That is, a most likely signal is generated by the neural network, and the actuator 22 operates based on this signal.

### Second Example

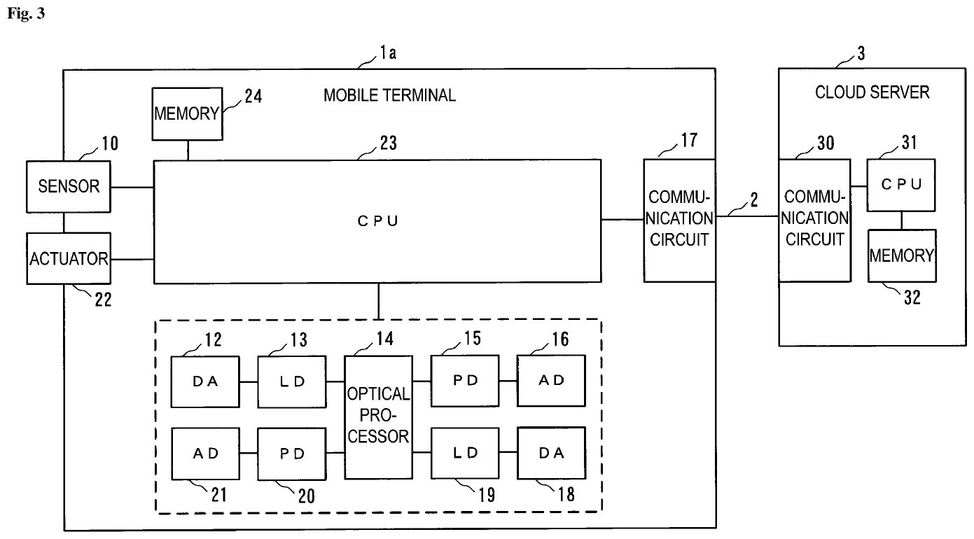

Next, a second example of the present disclosure will be described. FIG. 3 is a block diagram illustrating a configuration of a distributed deep learning system according to the second example of the present disclosure. The present example is a specific example of the first example. In a mobile terminal is of the present example, control of the sensor 10, the DAs 12 and 18, the LDs 13 and 19, the PDs 15 and 20, the ADs 16 and 21, the communication circuit 17, and the actuator 22 is performed by a CPU 23, and transmission and reception of an electrical signal in the mobile terminal 1a is controlled by the CPU 23. The CPU 23 is a general-purpose processor that performs the Neumann-type processing and executes processing in accordance with a program stored in the memory 24. Note that the buffer 11 in FIG. 1 is provided in the CPU 23.

For example, the CPU 23 outputs digital data output from the sensor 10 to the DA 12. Further, the CPU 23 also outputs digital data output from the AD 16 to the communication circuit 17. Processing of packetization of digital data may be performed by the CPU 23.

Further, the CPU 23 also outputs data received by the communication circuit 17 to the DA 18. At this time, processing in which the communication circuit 17 extracts payload data from the received packet may be performed by the CPU 23. Further, the CPU 23 outputs digital data output from the AD 21 to the actuator 22.

In this manner, in the present example, control of the sensor 10, the DAs 12 and 18, the LDs 13 and 19, the PDs 15 and 20, the ADs 16 and 21, the communication circuit 17, and the actuator 22 is performed by the CPU 23, thereby the needs of manual calibration and control of the mobile terminal is by the user are eliminated, and control can be achieved by a unified programming language.

According to the present example, productivity can be improved by reducing the manual labor by the user of the mobile terminal 1a. Even when the mobile terminal 1a is installed at a location that is not accessible to the user, the user can execute various controls by remotely operating the mobile terminal 1a. Therefore, even if there are several tens of thousands of the mobile terminals 1a, for example, control of these mobile terminals is can be automated. In the present example, resistance to malicious third-party attacks can be enhanced because common security techniques in the computer can be used.

### Third Example

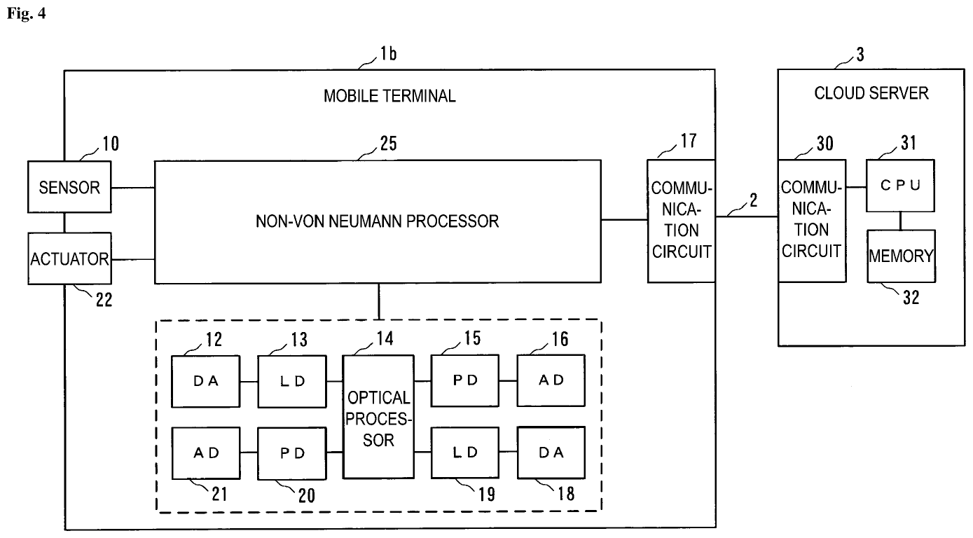

Next, a third example of the present disclosure will be described. FIG. 4 is a block diagram illustrating a configuration of a distributed deep learning system according to the third example of the present disclosure. The present example is another specific example of the first example. In a mobile terminal 1b of the present example, control of the sensor 10, the DAs 12 and 18, the LDs 13 and 19, the PDs 15 and 20, the ADs 16 and 21, the communication circuit 17, and the actuator 22 is performed by a non-von Neumann processor 25, and the control of transmission and reception of an electrical signal in the mobile terminal 1b is performed by the non-von Neumann processor 25.

The non-von Neumann processor 25 is a processor, which includes a dedicated circuit and a register, unlike a von Neumann processor.

For example, the non-von Neumann processor 25 outputs digital data output from the sensor 10 to the DA 12. Further, the non-von Neumann processor 25 outputs digital data output from the AD 16 to the communication circuit 17. As in the case of the CPU 23, processing of packetization of digital data may be performed by the non-von Neumann processor 25.

Further, the non-von Neumann processor 25 also outputs data received by the communication circuit 17 to the DA 18. At this time, processing in which the communication circuit 17 extracts payload data from the received packet may be performed by the non-von Neumann processor 25. Further, the non-von Neumann processor 25 outputs digital data output from the AD 21 to the actuator 22.

In the present example, by making all the operations of the CPU 23 of the second example into a dedicated circuit, unlike the second example, operations via memory can be reduced, and a circuit configuration can be minimized, thereby processing can be executed with low power consumption and low delay. When the high-performance DAs 12 and 18 and the ADs 16 and 21 are used, a bit rate per bus that cannot be achieved by a related art CPU can be achieved.

### Fourth Example

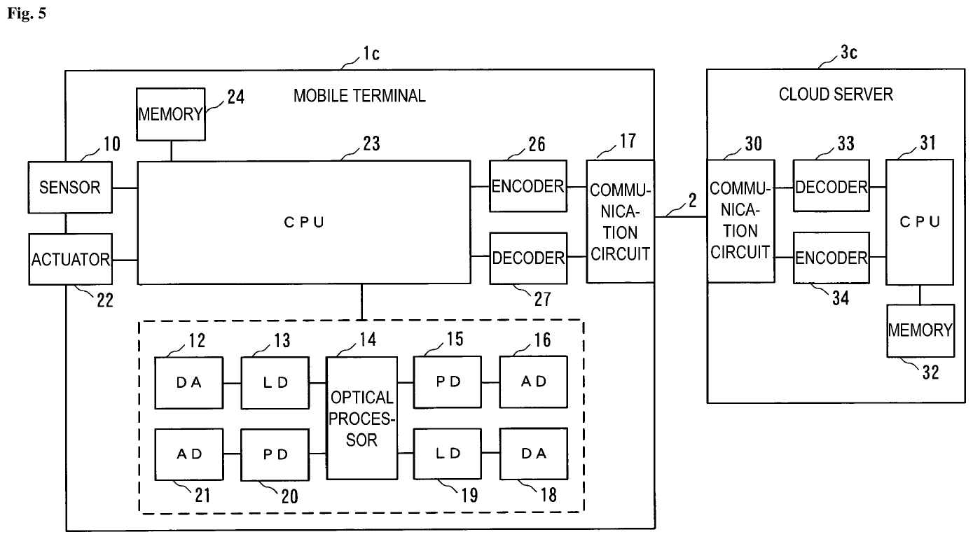

Next, a fourth example of the present disclosure will be described. FIG. 5 is a block diagram illustrating a configuration of a distributed deep learning system according to the fourth example of the present disclosure. The present example is another specific example of the first example. In a mobile terminal is of the present example, the CPU 23 outputs digital data output from the AD 16 to an encoder 26. The encoder 26 compresses the digital data output from the CPU 23 and outputs digital data after the compression to the communication circuit 17.

The communication circuit 17 packetizes the digital data output from the encoder 26 and transmits the generated packet to a cloud server 3c via the network 2.

The communication circuit 30 of the cloud server 3c extracts payload data from the packet received from the network 2 and outputs the data to a decoder 33.

The decoder 33 decompresses digital data output from the communication circuit 30 and outputs digital data after the decompression to the CPU 31. The decoder 33 returns the compressed digital data to a state before compression.

An encoder 34 of the cloud server 3c compresses digital data output from the CPU 31 and outputs digital data after the compression to the communication circuit 30. In addition to common lossless compression processing, the compression processing by the encoders 26 and 34 includes lossy compression processing such as bit reduction (quantization), compressed sensing, zero-skipping, and the like.

The communication circuit 17 of the mobile terminal is extracts payload data from a packet received from the cloud server 3c via the network 2 and outputs the data to a decoder 27.

The decoder 27 decompresses digital data output from the communication circuit 17 and outputs digital data after the decompression to the CPU 23. The CPU 23 outputs the digital data output from the decoder 27 to the DA 18.

In the first to third examples, a signal output by the AD 16 has a data amount obtained by multiplying a resolution of data of the AD 16 by a sampling rate of the AD 16, which may result in a large amount of data. Similarly, data output from the CPU 31 may result in a large amount of data. When such a large amount of data is transmitted and received via the network 2, the delay in communication becomes large.

In the present example, by compressing the data by the encoders 26 and 34, communication delay can be minimized. Further, in the present example, the amount of data transmission and reception is reduced, and thus the power consumption of the mobile terminal is can be reduced.

Note that the present example has been described with an example in which the CPU 23 is provided, but the non-von Neumann processor 25 may be used instead of the CPU 23 as described in the third example.

### Fifth Example

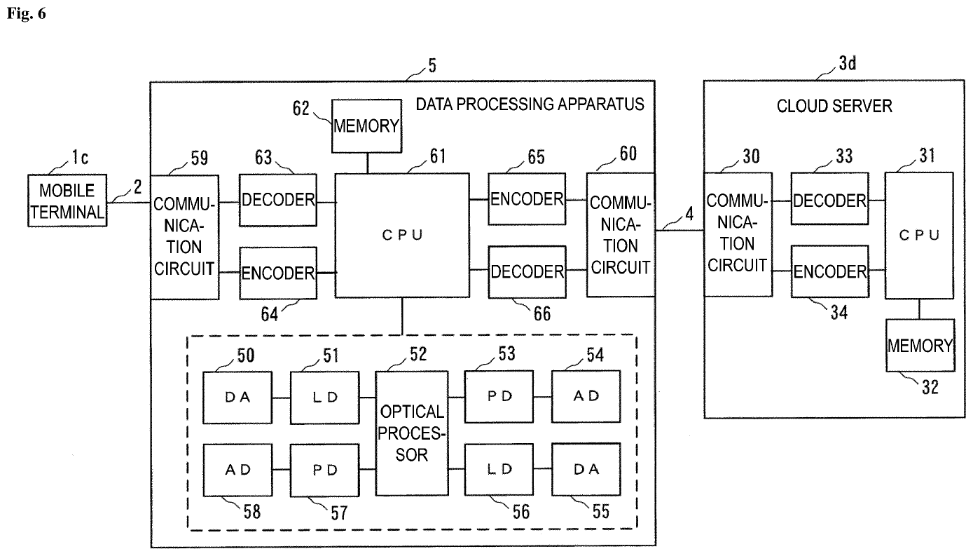

Next, a fifth example of the present disclosure will be described. FIG. 6 is a block diagram illustrating a configuration of a distributed deep learning system according to the fifth example of the present disclosure. The distributed deep learning system of the present example includes the mobile terminal 1c, a data processing apparatus 5 (first processing apparatus) connected to the mobile terminal is via a network 2, and a cloud server 3d (second processing apparatus) connected to the data processing apparatus 5 via a network 4. In the first to fourth examples, the deep learning is subjected to process in a distributed manner by two units, a mobile terminal and a cloud server. On the other hand, the present example further increases the number of units of the distributed processing.

The mobile terminal 1c is as described in the fourth example. The data processing apparatus 5 includes DAs 50 and 55, LDs 51 and 56, an optical processor 52, PDs 53 and 57, ADs 54 and 58, communication circuits 59 and 60, a CPU 61, a memory 62, decoders 63 and 66, and encoders 64 and 65. The data processing apparatus 5 is referred to as a base station, an edge server, and a fog. The data processing apparatus 5 is less power constrained than the mobile terminal is and performs computing at a location closer to the source of data than the cloud server 3d.

The CPU 61 of the data processing apparatus 5 executes processing according to a program stored in the memory 62.

The communication circuit 59 of the data processing apparatus 5 extracts payload data from a packet received from the mobile terminal is via the network 2 and outputs the data to the decoder 63.

The decoder 63 decompresses digital data output from the communication circuit 59 and outputs digital data after the decompression to the CPU 61.

The CPU 61 outputs data output from the decoder 63 to the DA 50. The DA 50 converts digital data output from the CPU 61 into an analog electrical signal. The LD 51 (second light emitting element) converts an analog electrical signal output from the DA 50 into an optical signal.

The optical processor 52 captures the optical signal emitted from the LD 51 and performs four arithmetic operations using interference on the internal optical waveguide with respect to the optical signal, and outputs an optical signal including an operation result.

The PD 53 (second light receiving element) converts the optical signal output from the optical processor 52 into an analog electrical signal. The AD 54 converts the analog electrical signal output from the PD 53 into digital data and outputs the digital data to the CPU 61.

The CPU 61 outputs the digital data output from the AD 54 to the encoder 65. The encoder 26 compresses the digital data output from the CPU 61 and outputs digital data after the compression to the communication circuit 60.

The communication circuit 60 packetizes the digital data output from the encoder 65 and transmits the generated packet to the cloud server 3d via the network 4. Further, the communication circuit 60 extracts payload data from a packet received from the cloud server 3d via the network 4 and outputs the data to the decoder 66.

The decoder 66 decompresses digital data output from the communication circuit 60 and outputs digital data after the decompression to the CPU 61. The CPU 61 outputs the digital data output from the decoder 66 to the DA 55.

The DA 55 converts the digital data output from the CPU 61 into an analog electrical signal. The LD 56 converts an analog electrical signal output from the DA 55 into an optical signal. The PD 57 converts the optical signal output from the optical processor 52 into an analog electrical signal. The AD 58 converts an analog electrical signal output from the PD 57 into digital data and outputs the digital data to the CPU 61.

The CPU 61 outputs the digital data output from the AD 58 to the encoder 64. The encoder 64 compresses the digital data output from the CPU 61 and outputs digital data after the compression to the communication circuit 59.

The communication circuit 59 packetizes the digital data output from the encoder 64 and transmits the generated packet to the mobile terminal 1c via the network 2.

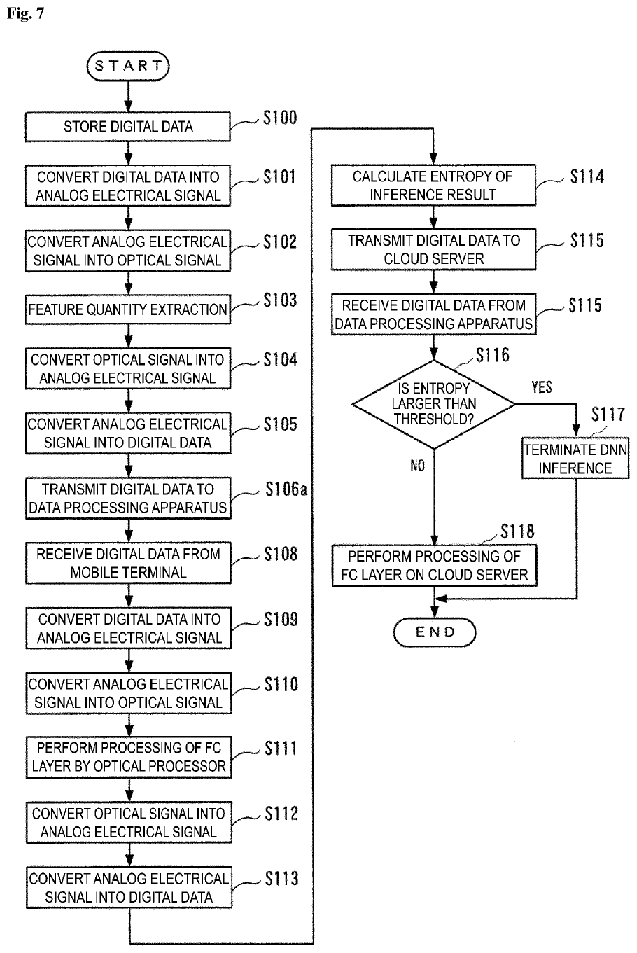

FIG. 7 is a flowchart describing an inference operation of the distributed deep learning system of the present example. Processing operations of steps S100 to S105 in FIG. 7 are similar to those of the first to fourth examples, and thus description thereof will be omitted.

The communication circuit 17 of the mobile terminal 1c packetizes the digital data and transmits the generated packet to the data processing apparatus 5 (step S106a in FIG. 7). At this time, the data transmitted by the communication circuit 17 is data compressed by the encoder 26 of the mobile terminal 1c.

The communication circuit 59 of the data processing apparatus 5 extracts payload data from a packet received from the network 2 and outputs the data to the decoder 63. The decoder 63 decompresses digital data output from the communication circuit 59 and outputs digital data after the decompression to the CPU 61 (step S108 in FIG. 7).

The CPU 61 outputs the digital data output from the decoder 63 to the DA 50. The DA 50 converts the digital data output from the CPU 61 into analog electrical signals (step S109 in FIG. 7).

The LD 51 of the data processing apparatus 5 converts the analog electrical signal output from the DA 50 into an optical signal (step S110 in FIG. 7).

The optical processor 52 of the data processing apparatus 5 performs a computational operation on an optical signal input from the LD 51. Thus, the optical processor 52 performs processing of the FC layer on the data transmitted by the optical signal (step S111 in FIG. 7).

The PD 53 of the data processing apparatus 5 converts an optical signal output from the optical processor 52 into an analog electrical signal (step S112 in FIG. 7). The AD 54 converts an analog electrical signal output from the PD 53 into digital data and outputs the digital data to the CPU 61 (step S113 in FIG. 7).

The CPU 61 of the data processing apparatus 5 calculates entropy of an inference result obtained by the optical processor 52 (step S114 in the figure).

The CPU 61 outputs the digital data output from the AD 54 and data including the calculated entropy to the encoder 65. The encoder 65 compresses the digital data output from the CPU 61 and outputs digital data after the compression to the communication circuit 60. The communication circuit 60 packetize the digital data output from the encoder 65 and transmits the generated packet to the cloud server 3d via the network 4 (step S115 in FIG. 7).

The communication circuit 30 of the cloud server 3d extracts payload data from the packet received from the network 4 and outputs the data to the decoder 33. The decoder 33 decompresses digital data output from the communication circuit 30 and outputs digital data after the decompression to the CPU 31 (step S115 in FIG. 7).

If a result of entropy included in the data output from the decoder 33 is larger than a predetermined threshold (YES in step S116 in FIG. 7), the CPU 31 of the cloud server 3d terminates the DNN inference (step S117 in FIG. 7).

Further, if the result of the entropy included in the data output from the decoder 33 is less than or equal to the threshold value (NO in step S116), the CPU 31 performs further processing of the FC layer on the inference result included in the data output from the decoder 33 (step S118 in FIG. 7). The FC layer of the cloud server 3d is an FC layer having a larger number of layers and a larger number of nodes than the FC layer of the data processing apparatus 5.

The DNN inference using a plurality of devices such as those described above is described in, for example, the literature “Surat Teerapittayanon, Bradley McDanel, H. T. Kung, “BranchyNet: Fast Inference via Early Exiting from Deep Neural Networks”, 2016 23rd International Conference on Pattern Recognition (ICPR). IEEE, 2016”.

In the present example, by using the optical processor 52 of the data processing apparatus 5 to process the FC layer, processing can be executed with low power consumption and low delay.

Note that the CPU 31 of the cloud server 3d generates control data, which is digital data for moving the actuator 22 of the mobile terminal 1c, as a result of processing using the inference result.

The communication circuit 30 of the cloud server 3d packetizes control data output from the CPU 31 and compressed by the encoder 34 and transmits the generated packet to the data processing apparatus 5 via the network 4.

The communication circuit 60 of the data processing apparatus 5 extracts payload data from the packet received from the cloud server 3d via the network 4 and outputs the data to the decoder 66.

The decoder 66 decompresses digital data output from the communication circuit 60 and outputs digital data after the decompression to the CPU 61.

The CPU 61 outputs the digital data output from the decoder 66 to the DA 55. The DA 55 converts the digital data output from the CPU 61 into an analog electrical signal. The LD 56 converts an analog electrical signal output from the DA 55 into an optical signal. The PD 57 converts the optical signal output from the optical processor 52 into an analog electrical signal. The AD 58 converts an analog electrical signal output from the PD 57 into digital data and outputs the digital data to the CPU 61.

The CPU 61 outputs the digital data output from the AD 58 to the encoder 64. The encoder 64 compresses the digital data output from the CPU 61 and outputs digital data after the compression to the communication circuit 59.

The communication circuit 59 packetizes the digital data output from the encoder 64 and transmits the generated packet to the mobile terminal 1c via the network 2. The operation in the mobile terminal 1c is as described in the fourth example.

The present examples have been described with respect to an example in which the encoders 26, 34, 64, and 65 and the decoders 27, 33, 63, and 66 are provided, but the encoders and decoders in the present disclosure are not essential configuration requirements. When the encoders and decoders are not used, the configurations of the mobile terminals 1, 1a, and 1b are used instead of that of the mobile terminal 1c. Further, instead of the cloud server 3d, the configuration of the cloud server 3 is used.

Furthermore, the present example has been described with an example in which the CPU 61 is provided in the data processing apparatus 5, but a non-von Neumann processor may be used instead of the CPU 61 as described in the third example.

### INDUSTRIAL APPLICABILITY

The present disclosure can be applied to distributed deep learning by using a mobile terminal.

### REFERENCE SIGNS LIST

1, 1a, 1b, and 1c . . . Mobile terminal
2 and 4 . . . Network
3, 3c, and 3d . . . Cloud server
5 . . . Data processing apparatus
10 . . . Sensor
11 . . . Buffer
12, 18, 50, and 55 . . . Digital-to-analog converter
13, 19, 51, and 56 . . . Laser diode
14 and 52 . . . Optical processor
15, 20, 53, and 57 . . . Photodiode
16, 21, 54, and 58 . . . Analog-to-digital converter
17, 30, 59, and 60 . . . Communication circuit
22 . . . Actuator
23, 31, and 61 . . . CPU
24, 32, and 62 . . . Memory
25 . . . non-von Neumann processor
26, 34, 64, and 65 . . . Encoder
27, 33, 63, and 66 . . . Decoder.

1.-7. (canceled)

8. A mobile terminal, comprising:
a sensor configured to acquire information from a surrounding environment and output a first electrical signal transmitting the information;
a first light emitting element configured to convert the first electrical signal output from the sensor into a first optical signal;
a first optical processor configured to extract a feature quantity of the information transmitted by the first optical signal and output a second optical signal including an extraction result;
a first light receiving element configured to convert the second optical signal output from the first optical processor into a second electrical signal; and
a first communication circuit configured to transmit the second electrical signal output from the first light receiving element to an external processing apparatus that performs processing of a full connection (FC) layer of a deep neural network (DNN) inference and receive a third electrical signal transmitted from the external processing apparatus.

9. The mobile terminal according to claim 8, further comprising:
an actuator configured to operate in accordance with a control signal,
wherein the first communication circuit is configured to receive the control signal transmitted from the external processing apparatus.

10. The mobile terminal according to claim 9, further comprising a central processing unit (CPU) or a non-von Neumann processor configured to control transmission and reception in the mobile terminal.

11. The mobile terminal according to claim 8, further comprising
a central processing unit (CPU) or a non-von Neumann processor configured to control transmission and reception in the mobile terminal.

12. The mobile terminal according to claim 8, further comprising:
an encoder configured to compress the first optical signal output from the first light receiving element into a compressed signal and output the compressed signal to the first communication circuit; and
a decoder configured to decompress the compressed signal received by the first communication circuit to return the compressed signal to a state before compression.

13. A distributed deep learning system, comprising:
a mobile terminal comprising:
a sensor configured to acquire information from a surrounding environment and output a first electrical signal transmitting the information;
a first light emitting element configured to convert the first electrical signal output from the sensor into a first optical signal;
a first optical processor configured to extract a feature quantity of the information transmitted by the first optical signal and output a second optical signal including an extraction result;
a first light receiving element configured to convert the second optical signal output from the first optical processor into a second electrical signal; and
a first communication circuit configured to transmit the second electrical signal output from the first light receiving element to a processing apparatus and receive a third electrical signal transmitted from the processing apparatus; and
a processing apparatus separate from the mobile terminal, the processing apparatus being configured to perform processing of a full connection (FC) layer of a deep neural network (DNN) on the second electrical signal received from the mobile terminal.

14. The distributed deep learning system according to claim 13, wherein the mobile terminal further comprises:
an actuator configured to operate in accordance with a control signal, wherein the first communication circuit is configured to receive the control signal transmitted from the processing apparatus.

15. The distributed deep learning system according to claim 14, wherein the mobile terminal further comprises:
a central processing unit (CPU) or a non-von Neumann processor configured to control transmission and reception in the mobile terminal.

16. The distributed deep learning system according to claim 13, wherein the mobile terminal further comprises:
a central processing unit (CPU) or a non-von Neumann processor configured to control transmission and reception in the mobile terminal.

17. The distributed deep learning system according to claim 13, wherein the mobile terminal further comprises:
an encoder configured to compress the first optical signal output from the first light receiving element into a compressed signal and output the compressed signal to the first communication circuit; and
a decoder configured to decompress the compressed signal received by the first communication circuit to return the compressed signal to a state before compression.

18. A distributed deep learning system, comprising:
a mobile terminal comprising:
a sensor configured to acquire information from a surrounding environment and output a first electrical signal transmitting the information;
a first light emitting element configured to convert the first electrical signal output from the sensor into a first optical signal;
a first optical processor configured to extract a feature quantity of the information transmitted by the first optical signal and output a second optical signal including an extraction result;
a first light receiving element configured to convert the second optical signal output from the first optical processor into a second electrical signal; and
a first communication circuit configured to transmit the second electrical signal output from the first light receiving element to a first processing apparatus;
a first processing apparatus configured to perform processing of a full connection (FC) layer of a deep neural network (DNN) on the second electrical signal received from the mobile terminal and calculate entropy of an inference result obtained by the processing of the FC layer; and
a second processing apparatus configured to terminate a DNN inference when a result of the entropy is larger than a threshold that is predetermined and further perform processing of the FC layer on the inference result transmitted from the first processing apparatus when the result of the entropy is less than or equal to the threshold,
wherein the first processing apparatus includes:
a second communication circuit configured to receive the second electrical signal transmitted from the mobile terminal;
a second light emitting element configured to convert the second electrical signal received by the second communication circuit into a third optical signal;
a second optical processor configured to perform processing of the FC layer of the DNN on a feature quantity transmitted by the third optical signal output from the second light emitting element and output a fourth optical signal including an inference result obtained by the processing of the FC layer;
a second light receiving element configured to convert the fourth optical signal output from the second optical processor into a third electrical signal; and
a third communication circuit configured to transmit the third electrical signal output from the second light receiving element to the second processing apparatus and receive a signal transmitted from the second processing apparatus.

19. The distributed deep learning system according to claim 18, wherein:
the first processing apparatus further includes a central processing unit (CPU) or a non-von Neumann processor configured to control transmission and reception of an electrical signal in the first processing apparatus and calculate the entropy.

20. The distributed deep learning system according to claim 18, wherein the mobile terminal further comprises:
an actuator configured to operate in accordance with a control signal, wherein the first communication circuit is configured to receive the control signal transmitted from the first processing apparatus.

21. The distributed deep learning system according to claim 18, wherein the mobile terminal further comprises:
an encoder configured to compress the first optical signal output from the first light receiving element into a compressed signal and output the compressed signal to the first communication circuit; and
a decoder configured to decompress the compressed signal received by the first communication circuit to return the compressed signal to a state before compression.
